(19) United States
(12) Patent Application Publication
(10) Pub. No.: US 2006/0048193 A1
(43) Pub. Date: Mar. 2, 2006

(54) I-Picture insertion on request

(76) Inventors: Lambert H A Jacobs, Bilzen (BE); Stefan R.J.C Detroch, Zichem (BE); Roelof E.A Reusens, Ranst (BE)

Correspondence Address: PHILIPS INTELLECTUAL PROPERTY & STANDARDS, 595 MINER ROAD, CLEVELAND, OH, 44143, US

(21) Appl. No.: 10/536,337

(22) PCT Filed: Oct. 29, 2003
(86) PCT No.: PCT/IB03/04896

§ 371 Date: May 25, 2005

(30) Foreign Application Priority Data
Nov. 27, 2002 (US) 60429670

(51) Int. Cl. H04N 7/18; H04N 7/173

(52) U.S. Cl. 725/81; 725/80; 725/112; 725/110

(57) ABSTRACT

A consumer entertainment system includes a video sender-box (10) configured to provide independent video frame insertion on request from one or more receivers (16) capable of requesting independent frame insertion or requesting the avoidance of the usage of lost pictures as reference frames. A network (14) connects the receivers to the video sender-box, and the video sender-box sends encoded independent and dependent video frames to the receivers complying with established standards.

This invention relates to the video or audiovisual transmission arts. It finds particular application when a sender-box supplies audiovisual content to one or multiple receivers utilizing a video format having independent reference frames, such as I-pictures in the MPEG2 format. However, it is to be appreciated that the invention will find application in other formats and applications.

Multimedia devices, such as analog TV-link and digital TV-link systems, have become popular with consumers in recent years. Home networking has recently become less expensive and more popular with consumers, particularly wireless home networking such as wireless LANs using IEEE 802.11 standards. The combination of these two recently popular technologies make it possible to have a set top box receiving a video broadcast and to act as a sender-box, providing the video over a local network to receivers dispersed throughout the home, and even throughout the premises such as in a garden or a detached garage for example. Consumers, however, prefer not to run wires throughout their home and, since powerful electronic chips have become inexpensive enough, it is economical to incorporate MPEG2 encoding in consumer entertainment devices networked via wireless home networking.

A difficulty is encountered when transmission errors occur between the sender-box and one or more receivers around the home. For example, a standard mechanism for non-streaming data connections is for the receiver to send a signal back to the sender-box with a request for re-transmission of the data that was lost or corrupted due to the transmission error. In a multimedia environment, particularly when viewing, this creates objectionable delays and momentary freezes of the display.

A better solution typically used in set top boxes is to wait passively for the next reference frame to be transmitted, I-frame in an MPEG2 encoded format. The I-frame has the necessary video information to construct a complete video frame, however, it is on average, half the interval between successive I-frames for the next I-frame to be received, typically 0.5 seconds. This delay again causes objectionable momentary freezes of the display, but only to receivers that experienced the problem. Another solution that can be adapted to set top boxes is for the sender-box to send only I-frames, for MPEG2 encoding, which eliminates the aforementioned delay. However, a disadvantage of this solution is that the bit-rate of the stream is typically too high for the network to handle or the quality is too low if the bit-rate is reduced.

It is desirable, therefore, to provide a system and method that provides a shorter period of video degradation or freezing following errors or other transmission interruptions without increasing the bit rate of the video transmission. It is also desirable to provide these improvements in such a manner that a standard video decoding such as MPEG2 may be used in the receivers.

It is further desirable to use a mechanism of I-picture insertion to provide better overall quality by inserting fewer I-frames. As I-frames typically require more bits of information than P or B frames, having fewer I-frames means a higher average bit-rate per frame, thus an overall quality improvement. In the extreme case, there would be no I-frames at all, except those requested as the result of a transmission error or if a new decoder is activated.

In accordance with one aspect of the present invention, a video display method is provided. The method includes receiving a digital or analog audio/video stream at a sender-box, encoding, re-encoding or transcoding the received digital or analog audio/video stream into a video stream of independent video frames and intervening dependent video frames, transferring the stream to one or more receivers, sensing a condition indicative of a transmission defect to at least one receiver, in response to sensing the condition, generating a request for an independent frame, and in response to the request, inserting an independent video frame into the video stream. The sensing a condition indicative of a transmission defect is performed by at least one of a picture defect detector on the receiver, a communications interface in the sender-box or receiver-box, a multiplex/de-multiplex section in the receiver and an encoding processor in the sender-box.

In accordance with another aspect of the present invention, a consumer entertainment system is provided. The consumer entertainment system includes an input means for receiving a video input, an encoding means for encoding the received video input into a digital audio/video stream including independent video frames and dependent video frames, and a means for transferring the video stream to one or more receivers. The consumer entertainment system also includes a means for sensing a condition indicative of a potential display defect on one or more of the receivers, a means for generating a request for an independent frame with the request being communicated by the transferring means to the encoding means which responds to the request by inserting an independent frame into the video stream.

One advantage of the present invention is that it provides a reduction in the time a video is degraded or frozen after a transmission interruption to below a level at which the average viewer will notice.

Another advantage is that the invention provides video at a reduced bit rate compared to typical prior art methods.

Yet another advantage is that the invention provides video at an improved quality compared to typical prior art methods when there are no transmission errors.

Still yet another advantage is that the invention utilizes well known video encoding standards such as MPEG2 which permit the use of commonly available receivers on the network, as well as receivers configured to request I-frame insertion.

Still further advantages of the present invention will become apparent to those of ordinary skill in the art upon reading and understanding the following detailed description of the preferred embodiments.

The invention may take form in various parts and arrangements of parts. The drawings are only for purposes of illustrating a preferred embodiment and are not to be construed as limiting the invention.

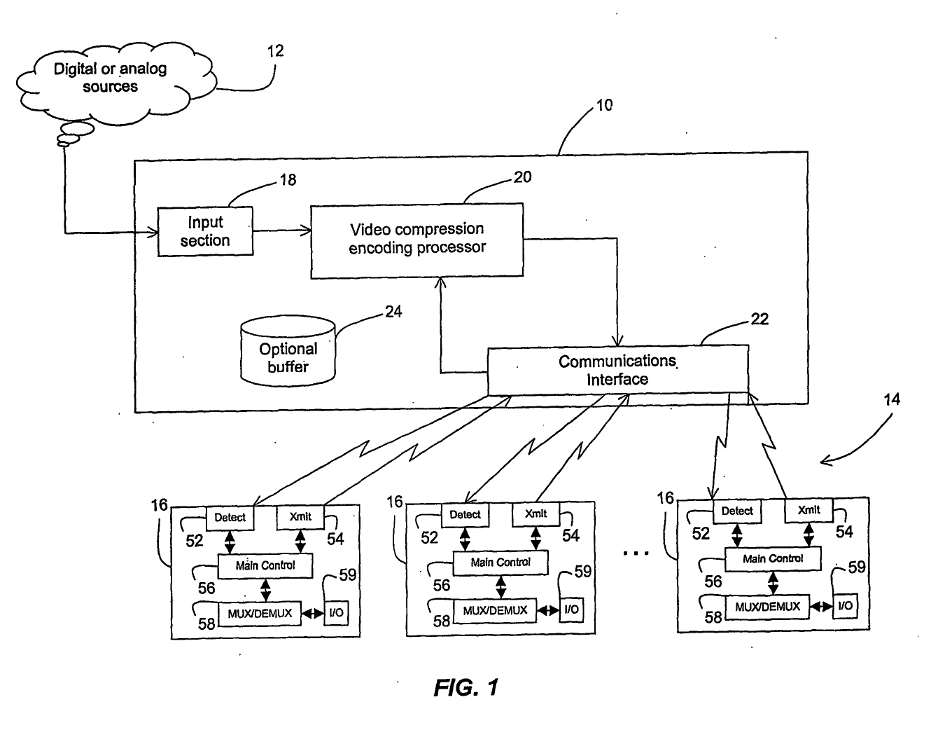

FIG. 1 is a block diagram of a sender-box and receivers in accordance with the present invention;

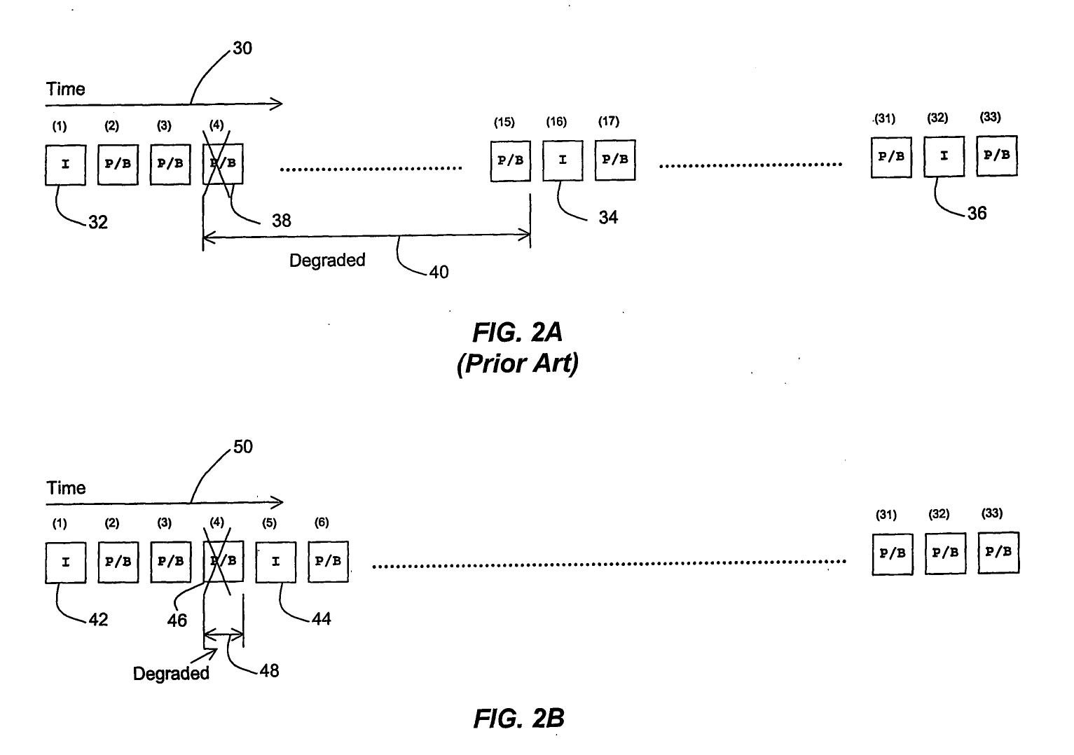

FIG. 2A is a time-line diagram of an MPEG2 transmission according to a prior art method;

FIG. 2B is a time-line diagram of an MPEG2 transmission according to an embodiment of the present invention;

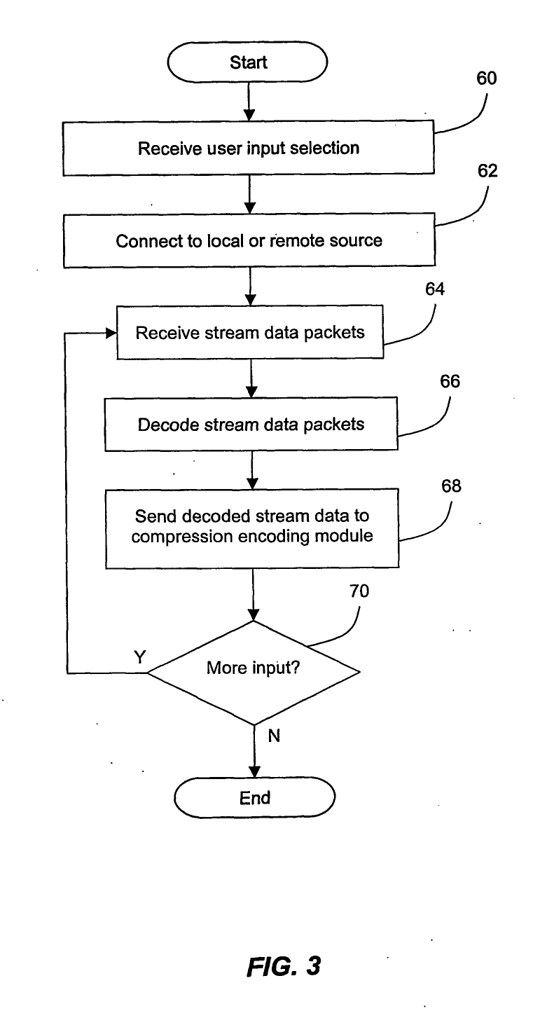

FIG. 3 is a flow chart of a server or sender-box input decoder method for network input according to an embodiment of the present invention;

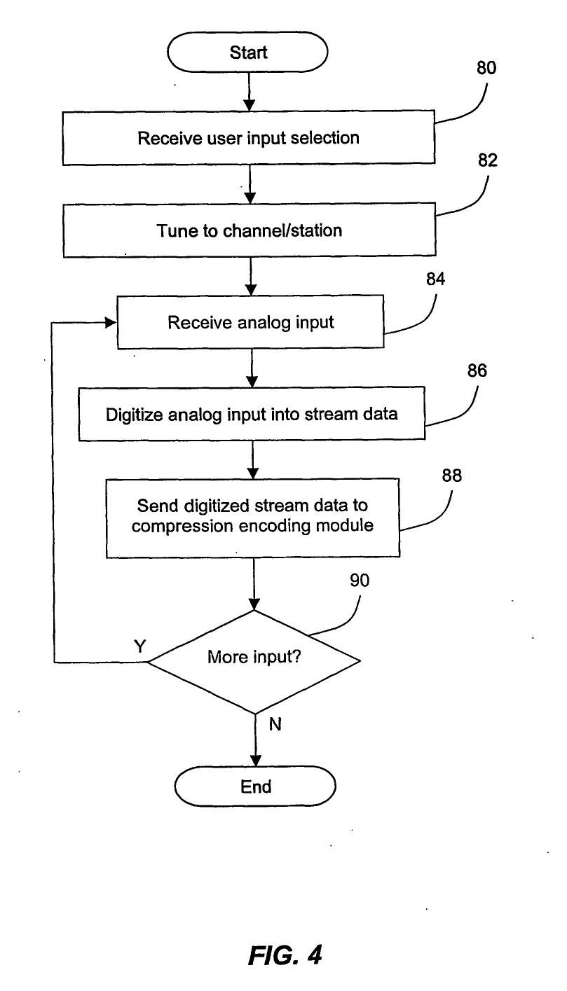

FIG. 4 is a flow chart of a server or sender-box input decoder method for analog input according to an embodiment of the present invention;

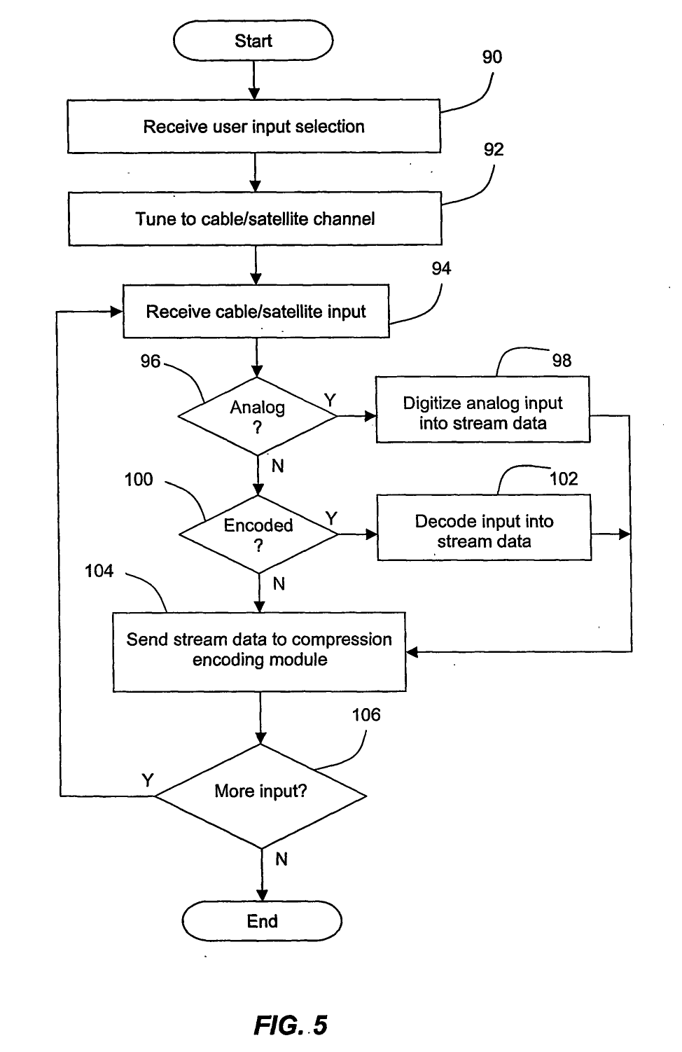

FIG. 5 is a flow chart of a server or sender-box input decoder method for cable/satellite input according to an embodiment of the present invention;

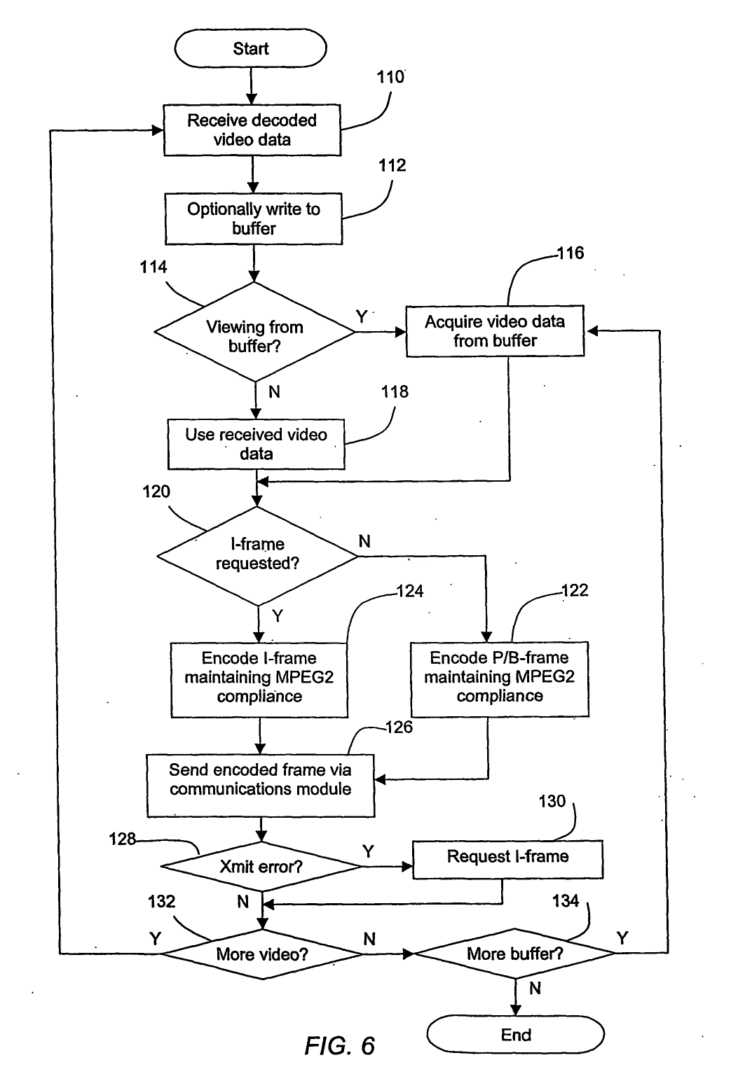

FIG. 6 is a flow chart of a server or sender-box encoder method according to an embodiment of the present invention; and

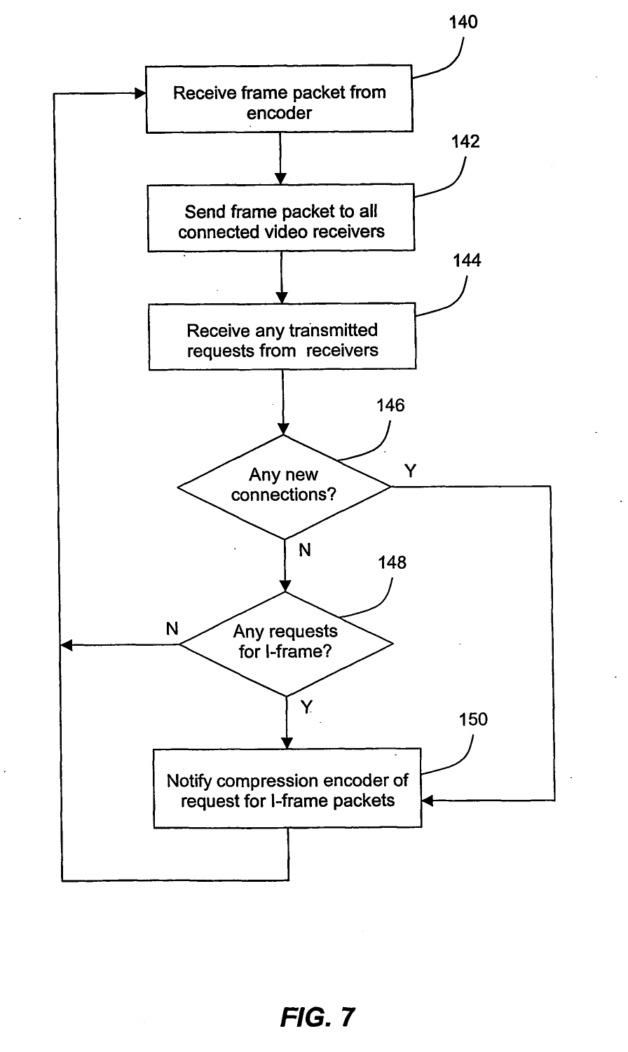

FIG. 7 is a flow chart of a server or sender-box communications module according to an embodiment of the present invention.

With reference to FIG. 1, a set top or sender box 10 acquires an analog audio/video stream in preferred embodiments, or a digital audio/video stream in alternate embodiments, from a video source 12 and sends encoded MPEG2 video frames via a wireless or wired network 14 to one or multiple receivers 16 for display to respective users. The video source 12 may be any source of video such as a broadcast received by a tuner, the Internet, a DVD player, satellite, etc. The network 14 may utilize any standard or non-standard network having sufficient bandwidth for the intended purpose, such as, for example, IEEE 802.11a, 802.11b, 802.11g and others. The receivers 16 include self-contained devices having a built-in display screen and also receivers that decode the incoming video signal for display on a separate device, for example, a receiver that outputs a CVBS (composite video blanking and synchs) signal for display on a television set. The receivers 16 may also include personal computers equipped to display video on an attached monitor.

The sender-box 10, including alternate devices such as PDAs, mobile phones laptop computers, video capture devices, cameras, CCD devices, web-cams or similar devices, includes an input video section 18, a digital or analog audio/video stream compression processor, encoder, re-encoder or transcoder 20, and a communications interface 22. The input section 18, in preferred embodiments, receives an analog input stream and converts it to a raw internal digital video format for further processing either by the input section 18 or by the digital audio/video stream encoder 20. In alternate embodiments, the input section receives video that has been encoded at the video source and converts it to a raw internal video format for further processing by the digital audio/video stream encoder 20.

The video encoder 20 converts the raw digital audio/video stream to a compressed format such as MPEG2 for transmission to one or more receivers 16. While the present application will be described primarily with respect to MPEG2 encoding, other encoding formats such as MPEG4 or DIVX, and future encoding formats, fall within the scope of the present application. The sender-box 10 may include a time-shift buffer 24 for recording encoded digital audio/video streams for delayed viewing, and may also include other features and controls typically found in set top boxes. However, these features and controls are not discussed in detail since knowledge of these is not necessary for understanding concepts of the embodiments described herein.

The MPEG2 format generally groups multiple video frames into a group of pictures (GOP). Each GOP begins with an I-frame, normally followed by a number of P and B frames. Each GOP can be as small as a single I-frame, and is typically less than 15 frames in length. I-frames are intra-coded frames with an average 7 to 1 reduction ratio. I-frames can be looked at as reference pictures that can be decoded without reference to previous frames. By distinction, P-frames and B-frames use data from previous or succeeding frames to decode a picture correctly. Therefore, the term I-frame as used herein, is defined to include video frame formats that include all of the data necessary to construct a complete picture frame without reference to earlier frames, hereinafter also referred to as independent frames or I-pictures. A JPEG or JPEG2000 image is an example of an independent frame. Also, a P-frame containing all I-macroblocks, for example, is an independent frame. It is also to be understood that the method of using 2 consecutive P-frames, in which e.g. the first updates the upper half of the picture, and the second updates the lower half, and other similar methods are included within the scope of the definition of I-frame as used herein. One can think of many variants, but they all come down to “rewriting the entire screen with independent picture data.”

Likewise, the terms P-frame and B-frame include video frame formats that are dependent on data from earlier or later frames in order to construct a complete video frame, hereinafter also referred to as dependent frames. P-frames are predicted based on prior I or P frames with the addition of data for changed macro blocks. P-frames average a 20 to 1 reduction ratio or about half the size of I frames. In one example, the P frame represents the difference between a current frame and an immediately preceding frame. B-frames are bi-directional predicted frames based on appearance with positions of past and future frame macro blocks. B-frames have less data than P-frames averaging about a 50 to 1 reduction ratio.

I-frames may be looked at as reference pictures that can be decoded without reference to previous frames. P-frames and B-frames require data from previous or succeeding frames to decode a picture correctly. While embodiments are described with respect to MPEG2 other formats similar in concept to MPEG2 may be employed and fall within the scope of the present application. In the case where MPEG4 is the selected format for the video encoder 20, each GOP can be as large as the maximum key frame interval, usually 200 to 300 frames.

In embodiments utilizing MPEG4, a decoder can use multiple frames as reference frames. If a transmission error occurs, an alternative to requesting an I-picture insertion is to send information to the encoder to avoid using the lost pictures as reference frames. In this manner, the encoding is still relatively efficient, even without the use of I-pictures.

Also, when a B-frame is lost or corrupt, the receiver decoding means can simply skip the B-frame and continue with the next frame without any harm and, therefore, it is not necessary to request I-frame insertion in such cases. It should also be understood that transmission errors can extend over a relatively prolonged period of time, wherein multiple frames are lost. In this case, a request for an I-frame insertion is usually needed to improve overall quality and provide faster error recovery.

In a typical set top box, the encoder sends I-frames on regular intervals, 1 I-frame for every 15 P/B-frames for example. To achieve a fixed bit rate for transmission, many systems have the encoder allocate and average the transmission rate over a GOP. In this scenario, when transmission data is lost due to communications problems, video degradation will continue to exist until the next I-frame transmission which may take as long as 0.5 seconds, or even longer. Under concepts of the present application, however, an improved method and apparatus for restoring video quality in a shorter time are provided without corrupting the images for users of other receivers.

FIG. 2A shows a time-line of I frames and P/B-frames according to typical prior art MPEG2-stream set top boxes, and illustrates the period of degradation that may occur when a frame is lost. In the figure, it is assumed for simplicity that a fixed GOP structure and a fixed GOP size are used. This is typically the case, however, the established standard permits a variable GOP structure and size. Temporal progression is from left to right as shown by time-line 30, with the first, second and third I-frames being identified by numerals 32, 34 and 36 respectively. I-frames 32-36 occur at fixed intervals with a fixed quantity of P/B-frames, unless at a scene change, interspersed between the I-frames. In the case where the one or more P/B-frames 38, following the first I-frame 32, is lost due to transmission errors, a period of degradation 40 occurs as shown from the P/B-frame 38 to the following I-frame 34. Analogously, if the receiver connects to the sender-box just as the P/B frame 38 is being received, the degradation period 40 is experienced while waiting for an initial I-frame. Video quality is restored upon transmission of the next I-frame 34 following the transmission error or initial connection.

FIG. 2B shows a time-line of I frames and P/B-frames according to a sender-box and receivers incorporating embodiments of the present application and illustrates, henceforth, a reduced period of degradation and average better quality. Temporal progression is again from left to right as shown by time-line 50, however, in this embodiment, I-frames are inserted in the video only as needed, or at a scene change, as illustrated by startup I-frame 42 and requested I-frame 44, rather than occurring at fixed intervals as in FIG. 2A. In this case, where one or more lost P/B-frame(s) 46 occurs due to a transmission error, one or more of the receivers 16 request an I-frame insertion resulting in the transmission of requested I-frame 44. A period of degradation 48 still occurs as shown, however, the period can, theoretically, be as short as the duration of the lost P/B-frame 46 although, due to MPEG2 compliancy considerations and other considerations, the period of degradation may be a few frames longer. In practice, the period of degradation may include an additional frame or two because of buffering considerations but a significant improvement is nonetheless achieved. Video quality is restored upon transmission of the requested I-frame 44, and the period of degradation has been advantageously reduced below a level at which the average viewer will notice as an appreciable disturbance.

It is to be understood that, while the illustrated embodiment only sends I-frames as needed, sending only P/B-frames when possible, other embodiments may send I-frames both at fixed intervals and as needed. However, the temporal frequency of the I-frames is advantageously reduced in order to lower the transmission bit rate without sacrificing video quality.

It is also to be emphasized that embodiments of the present application maintain a continuous stream of frames to the receivers and that the stream remains fully compliant with MPEG2 standards. This is important in the case of multiple receivers so that receivers not experiencing a transmission error are not affected by the requesting of an I-frame by another receiver. The quality of the stream is not noticeably affected by the I-frame insertion and each of the multiple receivers produces an improved overall viewing quality.

With reference again to FIG. 1, each receiver 16 includes a picture defect detector 52 which monitors for conditions that would cause a defect in the displayed content. Although errors may be detected at the receiver, errors may also be advantageously detected in the sender-box 10, communications interface 22 or the network component 14. Errors detected prior to detection by the defect detector 52 may be corrected on a more timely basis. Conditions detected by detector 52 include a corrupt digital data packet, the receiver being turned on, a momentary power disruption, or the like. Missing packets may also be detected. However, these are more likely detected by the network component 14.

In response to detecting a defect condition, a transmitter 54 signals the communications module 22 of the box 10 requesting the insertion of an I-frame as soon as possible. The video compression processor 20 responds by inserting an I-frame, or other reference pictures, into the digital audio/video stream that is being sent to the receivers.

Each receiver 16 also includes a main control section 56 in communication with the detector 52 and the transmitter 54 and a multiplexer/demultiplexer unit 58. The multiplexer/demultiplexer unit separates audio and video portions of streams for separate processing in an I/O section 59. The multiplexer/demultiplexer unit 58 is also capable of detecting defects and requesting I-frame insertion.

FIG. 3 provides a flow chart of a method suitable for incorporation into the input section 18 of the present application in the case of a WAN input, the Internet by way of example. The method shown is also suitable for locally attached devices such as a digital video (DV) camera via an IEEE 1394 capture card. In step 60, a user of set sender-box 10 selects a source, such as an internet radio/TV station or DV camera for example, and initiates reception of the respective audio/video stream. At step 62, a connection is made to the source and at step 64, the input section 18 receives the selected audio/video stream input and, at step 66 decodes the audio/video stream to a raw uncompressed video is format if necessary. If the input audio/video stream is not compressed or otherwise encoded, this step may be skipped.

While steps 64 and 66 are shown as separate steps, in practice they may be combined in a re-encoder, or when using only partial decoding/decompression. At step 68, the decoded digital audio/video stream is sent to the encoder module for further processing and, at step 70, if there is more video input, processing returns to step 64. It is to be understood that the flow charts presented in FIGS. 3-7 are abstracted as an aid to understanding concepts of the present application and that an actual implementation would include more detail than shown in the flow charts. For example, embodiments that include the buffer 24 may optionally perform time-shift buffering between the decoding step 66 and the sending step 68.

FIG. 4 provides a flow chart of a method suitable for incorporation into the input section 18 of the present application in the case of an analog input such as a public radio/TV broadcast. The method shown is also suitable even for locally attached devices such as a digital video (DV) camera when they are attached via an analog connection such as an S-video connector on an analog video capture card. In step 80, a user of the sender-box 10 selects a source, such as an analog broadcast from a TV station for example, and initiates reception of the respective audio/video stream. At step 82, the selected channel/station is tuned in and, the input section 18 receives the selected analog input at step 84. At step 86, the analog input is digitized, if necessary, to a raw uncompressed video format. If the analog input stream was digitized by the capture card, this step may be skipped.

While steps 84 and 86 are shown as separate steps, in practice they may be combined in a single chip or module. At step 88, the decoded digital audio/video stream is sent to the encoder module for further processing and, at step 90, if there is more video input, processing returns to step 84. FIG. 5 provides a flow chart of a method suitable for incorporation into the input section 18 of the present application in the case of an input from a source such as a satellite receiver or a digital cable TV receiver. In step 90, a user of set sender-box 10 selects a source, such as a satellite TV channel for example, and initiates reception of the respective audio/video stream. At step 92, the selected channel is tuned in and, the input section 18 receives the selected input at step 94. If a decision at step 96 determines that the input is an analog stream, the analog input is digitized at step 98 unless previously digitized by the cable TV receiver. If a decision at step 100 determines that the input is an encoded digital stream, the encoded input is decoded at step 102.

In all cases, processing continues at step 104 where the audio/video stream is sent to the encoder module for further processing and, at step 106, if there is more video input, processing returns to step 94. As with the previously described methods, steps 94-102 may be combined into a single function or chip in practice.

FIG. 6 presents a flow chart for a method suitable for implementation in video encoder 20. Decoded digital or analog audio/video data is received at step 110 for processing by the encoder. The received audio/video data may also be partially decoded, for example, for re-encoding or bitrate transcoding. If the sender-box 10 includes a time-shift buffer, step 112 is included in the method to write the digital audio/video stream to the time-shift buffer 24. Time-shifted data may, alternately, be held in input section 18. The data written to the time-shift buffer 24 is, preferably, encoded in a compressed format. Step 114 makes a determination as to whether the sender-box 10 is processing digital audio/video stream data from the time-shift buffer or processing the received digital audio/video stream data. In the former case, step 116 acquires digital audio/video stream data from the time-shift buffer and, if necessary, performs decompression to the desired format for further processing. If received digital or analog audio/video stream data is being displayed, step 118 causes it to be forwarded for further processing. In either case, step 120 is invoked to determine if an I-frame has been requested by one or more of receivers 16 and, if not, step 122 is performed next to encode P/B-frames. If an I-frame has been requested, step 124 is performed to encode an I-frame. The encoded I/P/B-frame is passed to the communications module 22 at step 126.

In the case where a transmission error is detectable by communications interface 22 as determined at step 128, an I-frame insertion is requested at step 130 in order to restore stream quality as soon as possible. Step 132 returns to step 110 for successive video processing if there is more audio/video stream data to be received from the video decoder 18. If the sender-box 10 is displaying buffered digital audio/video stream data from time-shift buffer 24, step 134 returns to step 116 to acquire additional digital audio/video stream data from the time-shift buffer.

While the method diagrammed in FIG. 6 shows an I-frame being transmitted immediately upon recognition of an I-frame request, this is not necessarily how it occurs in practice. Due to MPEG2 compliancy, or compliancy with alternate standards, there may be a delay of a few frames between the time of the request and the time that an I-frame can actually be inserted. Embodiments of the present application take this into account. It is important, however, that an I-frame be inserted as soon as possible and, for this reason, it is advantageous to detect a transmission error as soon as possible, preferably within sender-box 10.

FIG. 7 provides steps suitable for communications module 22 to enable I-frame insertion according to embodiments of the present application. At step 140, an encoded I/P/B-frame is received from the encoder 20. At step 142, the encoded frame is transmitted over the network 14 to all connected receivers 16. Although the method shown in FIG. 7 may incorporate uni-directional communications in some embodiments, in bi-directional embodiments, step 144 receives any requests from the connected receivers 16. Step 146 determines if any new connections have been made by the available receivers 16 and, if not, step 148 is performed to determine if any connected receiver has requested an I-frame insertion due to a transmission error. If either of steps 146 and 148 are answered in the affirmative, step 150 is invoked to notify the encoder 20 that an I-frame insertion has been requested, and, in all cases, processing returns to step 140 to receive additional encoded frames from the encoder 20. When a limited a limited number of the receivers 16 are connected, this method may be used with streaming internet based applications, provided that bandwidth constraints are not exceeded.

While the invention has been described with respect to I-frames and P/B-frames, it is to be appreciated that, as previously described, I-frames may be looked at as reference pictures that can be decoded without reference to previous frames, whereas P-frames and B-frames require data from previous or succeeding frames to decode a picture correctly. Therefore, various embodiments incorporating any video encoding method utilizing similar concepts fall within the scope of the present application.

Further, while the invention has been described with respect to receivers connected to a wireless network, it is to be appreciated that the invention is applicable to wired connections between the encoder and receivers. Therefore, various embodiments incorporating video encoders connected to one or multiple distant receivers with decoders connected via either a wired or wireless network fall within the scope of the present application.

Still further, while the invention has been described with respect to an in-home application having a sender-box, a set top box in particular, connected to one or more receivers it is to be appreciated that the scope of this application includes other uses of the concepts described herein. For example, uses may include converting video in a format that does not incorporate the concept of I-frames to a format such as MPEG2 that incorporates the concept of I-frames, thus enabling I-frame insertion according to the methods described herein. Another use might be the modification of a video format that incorporates the concept of I-frames by reducing the number of I-frames sent to connected receivers according to concepts of the present application.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A video display system comprising:
an input means for receiving an audio/video input;
an encoding means for encoding, re-encoding, or transcoding the received audio/video input into a video stream including:
independent video frames, and
dependent video frames;
a means for transferring the video stream to one or more receivers;
a means for sensing a condition indicative of at least one of a transmission error, a reception error and a potential display defect on one of the receivers; and
a means for generating a request for an independent frame, the request being communicated by the transferring means to the encoding means which responds to the request by inserting an independent frame into the video stream.

2. The system as set forth in claim 1, wherein the encoding means encodes video conforming to IEEE MPEG2 standards in which the independent video frames are I-frames and the dependent frames include at least one of P-frames and B-frames.

3. The system as set forth in claim 1, wherein the independent video frames inserted on request are at least one of:
MPEG2 format P-frames containing all I-macroblocks; and
MPEG2 format B-frames containing all 1-macroblocks.

4. The system as set forth in claim 1, wherein the transferring means includes a wireless network.

5. The system as set forth in claim 4, wherein the wireless network conforms to at least one of:
IEEE 802.11 standards;
Ethernet standards;
Internet standards;
Radio Frequency (RF) standards;
Digital Enhanced Cordless Telephone (DECT) standards; and
Bluetooth standards.

6. The system as set forth in claim 1, wherein the condition which triggers the independent video frame insertion request includes at least one of:
a network transmission error;
a missing video frame is detected by one of the receivers; and
activation of one of the receivers.

7. A video display system comprising:
a video sender-box which generates a stream of independent and dependent video frames and which is configured to:
insert an independent video frame into the stream on request; and
avoid usage of lost reference pictures as reference pictures on request;
one or more receivers which convert the stream of independent and dependent video frames into a human viewable display;
a means for requesting insertion of an independent frame into the stream; and
a network connecting the receivers to the video sender-box to communicate the stream of independent and dependent video frames and the insertion requests.

8. The system as set forth in claim 7, wherein the video sender-box includes:
a video compression encoder, re-encoder or transcoder for generating independent and dependent video frames from an input video source, the video encoder, re-encoder or transcoder generating independent video frames in response to receipt of an insertion request.

9. The system as set forth in claim 8, wherein the video compression encoder encodes, re-encodes or transcodes video frames to be compatible with MPEG2, MPEG4 or DIVX standards.

10. The system as set forth in claim 7, wherein the network includes a wireless network.

11. The system as set forth in claim 10, wherein the wireless network conforms to IEEE 802.11 standards, Ethernet standards, Internet standards, RF standards DECT standards or Bluetooth standards.

12. The system as set forth in claim 8, further including:
an input video decoder for decoding input video frames to a raw internal video format prior to encoding by video compression encoder.

13. A video display method comprising:
receiving digital or analog audio/video stream data;
at least one of encoding, re-encoding, and transcoding the received audio/video stream data into a video stream of independent video frames and intervening dependent video frames;
transferring the stream to one or more receivers;
sensing a condition indicative of at least one of a display defect, a transmission error, and a reception error at one of the receivers;
in response to sensing the condition, generating a request for an independent frame; and
in response to the request, inserting an independent video frame into the video stream as soon as possible.

14. The method as set forth in claim 13, wherein the encoding step includes one or more of encoding an independent frame at fixed intervals in a multiplicity of dependent frames, on scene changes and at times beneficial to improved compression, as well as on request.

15. The method as set forth in claim 14, wherein in the fixed interval there are more than 15 dependent frames between each independent frame.

16. The method as set forth in claim 13, wherein an independent video frame is inserted into a stream of dependent frames only on request.

17. The method as set forth in claim 13, wherein conditions for requesting an independent frame include at least any one of:
a video transmission error;
detection of a missing frame;
detection of a missing packet; and
turning a receiver on.

18. The method as set forth in claim 13, wherein the encoding steps encode video frames complying with at least one of:
MPEG2 standards;
MPEG4 standards; and
DIVX standards.

19. The method as set forth in claim 18, wherein the independent frames are one or more of I-frames and multiple reference frames, and the dependent frames are one or more of P-frames and B-frames.
